(19) United States
(12) Patent Application Publication
(10) Pub. No.: US 2021/0127460 A1
(43) Pub. Date: Apr. 29, 2021

(54) COOKING APPARATUS AND DRIVING METHOD THEREOF

(71) Applicant: Samsung Electronics Co., Ltd., Suwon-si (KR)

(72) Inventors: Jiwoong CHOI, Suwon-si (KR); Hongjoo KANG, Suwon-si (KR); Namju PARK, Suwon-si (KR); Semin LEE, Suwon-si (KR); Taeho LEE, Suwon-si (KR)

(21) Appl. No.: 17/079,351

(22) Filed: Oct. 23, 2020

(30) Foreign Application Priority Data
Oct. 23, 2019 (KR) 10-2019-0132527

(51) Int. Cl. H05B 6/06; H05B 6/12; H05B 6/04

(52) U.S. Cl. CPC H05B 6/065; H05B 6/04; H05B 6/1272

(57) ABSTRACT

A cooking apparatus is disclosed. The cooking apparatus includes a cooking plate including a plurality of heating areas, a plurality of induction coils in locations corresponding to each of the plurality of heating areas in the lower part of the cooking plate, a driver supplying currents to each of the plurality of induction coils, and a processor. The processor is configured to, based on a user instruction for turning on a second heating area among the plurality of heating areas being received while a first heating area among the plurality of heating areas is turned on, stop the supply of a current to a first induction coil corresponding to the first heating area among the plurality of induction coils during a threshold time.

### CROSS-REFERENCE TO RELATED APPLICATION

This application is based on and claims priority under 35 U.S.C. § 119(a) to Korean Patent Application No. 10-2019-0132527 filed on Oct. 23, 2019 in the Korean Intellectual Property Office, the disclosure of which is incorporated by reference herein in its entirety.

### BACKGROUND

### 1. Field

The disclosure relates to a cooking apparatus and a driving method thereof, and more particularly, to a cooking apparatus that includes induction coils, and a driving method thereof.

### 2. Description of Related Art

Following the recent development of electronic technologies, various types of electronic apparatuses are being developed and distributed.

In particular, various induction heating cooking apparatuses which do not generate fine dust and harmful gases and cause little risk of an outbreak of fire, unlike conventional heating apparatuses which use fossil fuels such as gases or oils, are being developed and distributed.

Such induction heating cooking apparatuses can generate Joule heat by resistance components of a cooking container itself by using the principle of induction heating, and heat the container by using the Joule heat.

As an induction heating cooking apparatus uses the principle of induction heating, in the case of driving two or more working coils simultaneously, there is a problem that a magnetic field interference noise occurs as output frequencies are different between the working coils.

### SUMMARY

The disclosure is for addressing the aforementioned need, and the purpose of the disclosure is in providing a cooking apparatus that controls frequencies of each of a plurality of induction coils, and a driving method thereof.

According to an embodiment of the disclosure for achieving the aforementioned purpose, a cooking apparatus includes a cooking plate including a plurality of heating areas, a plurality of induction coils that are provided in locations corresponding to each of the plurality of heating areas in the lower part of the cooking plate, a driver supplying currents to each of the plurality of induction coils, and a processor configured to, based on a user instruction for turning on a second heating area among the plurality of heating areas being received while a first heating area among the plurality of heating areas is turned on, stop the supply of a current to a first induction coil corresponding to the first heating area among the plurality of induction coils during a threshold time.

Here, the processor may, while both of the first heating area and the second heating area are turned on, control the driver to adjust the strength of at least one of a first current or a second current such that the difference between the strength of the first current supplied to the first induction coil and the strength of the second current supplied to the second induction coil corresponding to the second heating area belongs to a threshold range.

Here, the processor may, based on the strength of at least one of the first current or the second current being adjusted, adjust the time that the current of which strength has been adjusted is supplied based on the adjusted strength of the current.

Also, the processor may increase the strength of at least one of the first current or the second current, generate a pulse width modulation (PWM) signal for adjusting the time that the current of which strength has been increased is supplied based on the increased strength of the current, and provide the signal to the driver.

In addition, the processor may adjust the time that the current of which strength has been adjusted is supplied such that the average output power of a heating area corresponding to an induction coil to which the current of which strength has been adjusted is supplied is identical to the output power before the adjustment.

Further, the driver may include a first switch controlling supply of a current to the first induction coil, a second switch controlling the frequency of the current supplied to the first induction coil, a third switch controlling supply of a current to the second induction coil, and a fourth switch controlling the frequency of the current supplied to the second induction coil. Also, the processor may control the supply time of the first current by controlling the switching frequency of the first switch, control the supply time of the second current by controlling the switching frequency of the third switch, control the strength of the first current by controlling the switching frequency of the second switch, and control the strength of the second current by controlling the switching frequency of the fourth switch.

Here, the processor may, after transmitting a pulse width modulation (PWM) signal for controlling supply of a current to the first induction coil to the driver, based on a feedback signal corresponding to the PWM signal not being received from the driver, control the first switch and stop supply of a current to the first induction coil.

Also, the processor may, based on a user instruction for turning on the second heating area being received, gradually increase the strength of a current supplied to the second induction coil corresponding to the second heating area among the plurality of induction coils.

In addition, the threshold time may be time required for the strength of the current supplied to the second induction coil corresponding to the second heating area to be identical to the strength of the current corresponding to the user instruction.

Further, the processor may sense an output signal of the first induction coil by a time interval determined based on a driving frequency of the first induction coil, and based on the size of the output signal being greater than or equal to a threshold size based on the maximum size among the sensed sizes of the output signal, control the driver such that the size of the output signal of the first induction coil maintains the threshold size.

A driving method of a cooking apparatus comprising a cooking plate, a plurality of induction coils that are provided in the lower part of the cooking plate, and a driver supplying currents to each of the plurality of induction coils according to an embodiment of the disclosure for achieving the aforementioned purpose includes the steps of receiving a user instruction for turning on a second heating area among the plurality of heating areas while a first heating area among the plurality of heating areas included in the cooking plate is turned on, and stopping the supply of a current to a first induction coil corresponding to the first heating area among the plurality of induction coils during a threshold time.

Here, the driving method may include the step of, while both of the first heating area and the second heating area are turned on, controlling the driver to adjust the strength of at least one of a first current or a second current such that the difference between the strength of the first current supplied to the first induction coil and the strength of the second current supplied to the second induction coil corresponding to the second heating area belongs to a threshold range.

Here, the step of controlling the driver may include the step of, based on the strength of at least one of the first current or the second current being adjusted, adjusting the time that the current of which strength has been adjusted is supplied based on the adjusted strength of the current.

Also, the step of controlling the driver may include the steps of increasing the strength of at least one of the first current or the second current, generating a pulse width modulation (PWM) signal for adjusting the time that the current of which strength has been increased is supplied based on the increased strength of the current, and providing the signal to the driver.

In addition, the step of controlling the driver may include the step of adjusting the time that the current of which strength has been adjusted is supplied such that the average output power of a heating area corresponding to an induction coil to which the current of which strength has been adjusted is supplied is identical to the output power before the adjustment.

Further, the driver may include a first switch controlling supply of a current to the first induction coil, a second switch controlling the frequency of the current supplied to the first induction coil, a third switch controlling supply of a current to the second induction coil, and a fourth switch controlling the frequency of the current supplied to the second induction coil. Also, the step of controlling the driver may include the steps of controlling the supply time of the first current by controlling the switching frequency of the first switch, controlling the supply time of the second current by controlling the switching frequency of the third switch, controlling the strength of the first current by controlling the switching frequency of the second switch, and controlling the strength of the second current by controlling the switching frequency of the fourth switch.

Here, the driving method may include the steps of transmitting a pulse width modulation (PWM) signal for controlling supply of a current to the first induction coil to the driver, and based on a feedback signal corresponding to the PWM signal not being received from the driver, controlling the first switch and stopping supply of a current to the first induction coil.

Also, the driving method may include the step of, based on a user instruction for turning on the second heating area being received, gradually increasing the strength of a current supplied to the second induction coil corresponding to the second heating area among the plurality of induction coils.

In addition, the threshold time may be time required for the strength of the current supplied to the second induction coil corresponding to the second heating area to be identical to the strength of the current corresponding to the user instruction.

Further, the driving method may include the steps of sensing an output signal of the first induction coil by a time interval determined based on a driving frequency of the first induction coil, and based on the size of the output signal being greater than or equal to a threshold size based on the maximum size among the sensed sizes of the output signal, controlling the driver such that the size of the output signal of the first induction coil maintains the threshold size.

According to the various embodiments of the disclosure, generation of a noise due to another heating area which is in a turned-on state when a heating area is turned on can be prevented.

Also, according to the various embodiments of the disclosure, the strength of currents supplied to each of a plurality of induction coils can be prevented, and accordingly, generation of a magnetic field interference noise can be prevented.

In addition, according to the various embodiments of the disclosure, if a threshold voltage is detected, a cooking apparatus can be protected from breakage through a protection control.

Further, according to the various embodiments of the disclosure, Joule heat can be generated by using a driver by a single-ended method, and a cooking container can be heated smoothly without generation of a noise.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram illustrating a configuration of a cooking apparatus according to an embodiment of the disclosure;

FIG. 2 illustrates a diagram illustrating an exterior of a cooking apparatus according to an embodiment of the disclosure;

FIG. 3 illustrates a diagram for illustrating a driver and an induction coil according to an embodiment of the disclosure;

FIG. 4 illustrates a diagram for illustrating the strength of a current according to an embodiment of the disclosure;

FIG. 5 illustrates a diagram for illustrating a detailed configuration of a driver according to an embodiment of the disclosure;

FIG. 6 illustrates a diagram for illustrating a resonance voltage according to an embodiment of the disclosure;

FIG. 7 illustrates a diagram for illustrating a feedback signal according to an embodiment of the disclosure;

FIG. 8 illustrates a block diagram illustrating a detailed configuration of a cooking apparatus according to an embodiment of the disclosure;

FIG. 9 illustrates a diagram for illustrating a driver according to another embodiment of the disclosure; and

FIG. 10 illustrates a flow chart for illustrating a driving method of a cooking apparatus according to an embodiment of the disclosure.

### DETAILED DESCRIPTION

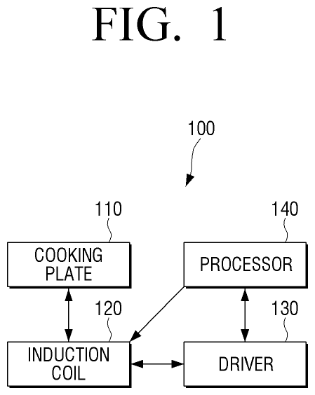

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

First, terms used in this specification will be described briefly, and then, the disclosure will be described in detail.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies. Also, in particular cases, there are terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. Meanwhile, in case it is determined that in describing embodiments, detailed explanation of related known technologies may unnecessarily confuse the gist of the disclosure, the detailed explanation will be omitted.

Also, the terms “first,” “second” and the like used in the disclosure may be used to describe various elements, but the terms are not intended to limit the elements. Such terms are used only to distinguish one element from another element.

In addition, singular expressions also include plural expressions as long as the context does not clearly indicate otherwise. In addition, in the disclosure, terms such as “include” and “consist of” should be construed as designating that there are such characteristics, numbers, steps, operations, elements, components or a combination thereof described in the specification, but not as excluding in advance the existence or possibility of adding one or more of other characteristics, numbers, steps, operations, elements, components or a combination thereof.

Also, in the disclosure, “a module” or “a part” performs at least one function or operation, and may be implemented as hardware or software, or as a combination of hardware and software. Further, a plurality of “modules” or “parts” may be integrated into at least one module and implemented as at least one processor (not shown), except “modules” or “parts” which need to be implemented as specific hardware.

Hereinafter, the embodiments of the disclosure will be described in detail with reference to the accompanying drawings, such that those having ordinary skill in the art to which the disclosure belongs can easily carry out the disclosure. However, it should be noted that the disclosure may be implemented in various different forms, and is not limited to the embodiments described herein. Also, in the drawings, parts that are not related to explanation were omitted, for explaining the disclosure clearly, and throughout the specification, similar components were designated by similar reference numerals.

FIG. 1 illustrates a block diagram illustrating a configuration of a cooking apparatus according to an embodiment of the disclosure.

According to what is illustrated in FIG. 1, a cooking apparatus 100 according to an embodiment of the disclosure includes a cooking plate 110, a plurality of induction coils 120, a driver 130, and a processor 140.

The cooking apparatus 100 is a home appliance that cooks food, and it may be a gas oven that heats food by combusting a gas, an electronic oven that heats food by converting electric energy into heat energy, a microwave oven that heats food by irradiating a microwave on the food, a gas range that heats a container containing food by combusting a gas, an apparatus that heats a cooking container containing food by generating a magnetic field, an induction apparatus, a highlight apparatus, etc. Hereinafter, for the convenience of explanation, explanation will be made based on the assumption that the cooking apparatus 100 is an induction apparatus.

In the upper part of the cooking apparatus 100, a cooking plate 110 having a form of a plate on which a cooking container can be placed may be provided. The cooking plate 110 according to an embodiment of the disclosure may be implemented as tempered glass such as ceramic glass so that it is not broken easily.

In one area of the cooking plate 110 according to an embodiment of the disclosure, an input panel (not shown) receiving a user instruction related to control of the cooking apparatus 100 may be provided. According to an embodiment of the disclosure, an input panel may include a touch area receiving inputs of user instructions for controlling various functions of the cooking apparatus 100. Here, a user instruction may be a turn-on/turn-off instruction of the cooking apparatus 100 itself, a turn-on/turn-off instruction of each of a plurality of heating areas provided on the cooking plate 110, an instruction for adjusting the strength of output power, a timer setting instruction, etc.

Also, in one area of the cooking plate 110 according to an embodiment of the disclosure, a display (not shown) displaying state information of the cooking apparatus 100 may be provided. Locations of an input panel and a display are not limited to the top of the cooking plate 110, but they may be provided in various locations such as the front surface and/or the side surface, etc. of the cooking apparatus 100. For example, an input panel may be provided on the side surface of the cooking apparatus 100, and a display may be provided on the front surface of the cooking apparatus 100.

In particular, the cooking plate 110 may include a plurality of heating areas. Here, on each of the plurality of heating areas, a cooking container may be placed, and the cooking apparatus 100 may identify induction coils 120 corresponding to heating areas on which cooking containers are placed.

Each of the plurality of induction coils 120 according to an embodiment of the disclosure may generate a magnetic field or an electromagnetic field for heating a cooking container. As an example, each of the plurality of induction coils 120 may be provided in a location corresponding to each of the plurality of heating areas in the lower part of the cooking plate 110. For example, a first induction coil may be provided in a location corresponding to a first heating area among the plurality of heating areas. The first induction coil may generate a magnetic field in the first heating area and heat a cooking container placed on the first heating area. Meanwhile, the first induction coil corresponding to the first heating area may be implemented as one induction coil, and it can also be implemented as a plurality of sub induction coils. Here, a plurality of sub induction coils may mean a group (or, an array) of induction coils implemented in relatively smaller sizes than the sizes of the heating areas. Meanwhile, the induction coils 120 may also be referred to as induction heating coils, working coils, etc., but for the convenience of explanation, they will be generally referred to as induction coils 120.

The driver 130 according to an embodiment of the disclosure may supply currents to each of the plurality of induction coils. As an example, when the driver 130 supplies currents to the induction coils 120, a magnetic field may be induced around the induction coils 120. Also, the driver 130 may supply alternating currents to the induction coils 120, and around the induction coils 120, a magnetic field of which size and direction change according to time may be generated.

A magnetic field generated around the induction coils 120 may pass through the cooking plate 110, and reach a cooking container placed on the cooking plate 110. Because of the magnetic field of which size and direction change according to time, an eddy current (EI) that rotates around the magnetic field may be generated in the cooking container.

Because of the eddy current (EI), electronic resistance heat may be generated in the cooking container. Here, electronic resistance heat is heat that is generated in a resistor when a current flows in the resistor, and it is also referred to as Joule heat.

By such electronic resistance heat, a resistor, i.e., a cooking container can be heated. Like this, each of the plurality of induction heating coils may heat a cooking container by using electromagnetic induction and electronic resistance heat.

Meanwhile, the cooking apparatus 100 according to an embodiment of the disclosure may include a plurality of drivers 130, and each of the plurality of drivers 130 may correspond to the induction coils 120. For example, a first driver may supply a current to the first induction coil, and a second driver may supply a current to the second induction coil.

The processor 140 controls the overall operations of the cooking apparatus 100.

According to an embodiment of the disclosure, the processor 140 may be implemented as a digital signal processor (DSP), a microprocessor, a time controller (TCON), etc. However, the disclosure is not limited thereto, and the processor 140 may include one or more of a central processing unit (CPU), a micro controller unit (MCU), a micro processing unit (MPU), a controller, an application processor (AP), a graphics-processing unit (GPU) or a communication processor (CP), and an ARM processor, or may be defined by the terms. Also, the processor 140 may be implemented as a system on chip (SoC) having a processing algorithm stored therein or large scale integration (LSI), or in the form of a field programmable gate array (FPGA). The processor 140 may perform various functions by executing computer executable instructions stored in a memory.

In particular, the processor 140 according to an embodiment of the disclosure may adjust the strength of currents that the driver 130 supplies to the induction coils 120.

If the strength of currents that the driver 130 supplies to the induction coils 120 increases, the strength of a magnetic field generated around the induction coils 120 also increases. Subsequently, as the strength of the magnetic field increases, the output power of the heating areas may also increase. As another example, if the strength of currents that the driver 130 supplies to the induction coils 120 decreases, the strength of a magnetic field generated around the induction coils 120 also decreases. Subsequently, as the strength of the magnetic field decreases, the output power of the heating areas may also decrease.

As an example, if a user instruction regarding an output level is received, the driver 130 may supply currents having strength corresponding to the output level to the induction coils 120 according to control by the processor 140. Then, the induction coils 120 may generate a magnetic field corresponding to the strength of the currents. Output power of a heating area may be in proportion to the strength of the magnetic field generated by the induction coils 120. Here, output power may indicate the size of electronic resistance heat that is generated in a resistor (e.g., a cooking container). Meanwhile, an output level according to a user instruction may not be an absolute value of output power of a heating area, but an output level may mean a relative value representing output power of a heating area. As an example, output power of a heating area corresponding to ‘level 5’ may be relatively bigger than output power of a heating area corresponding to ‘level 3.’

Meanwhile, the processor 140 according to an embodiment of the disclosure may control the driver 130 and adjust the time that currents are supplied to the induction coils 120 and the strength of currents supplied to the induction coils 120.

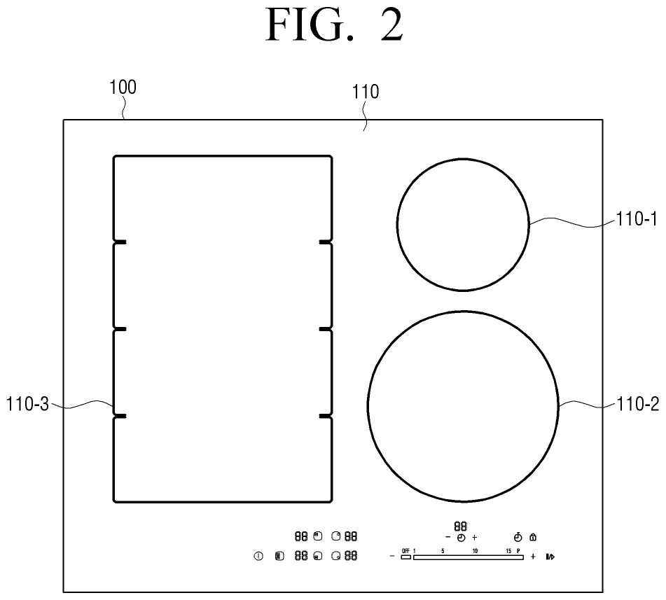

As an example, if a user instruction for turning on a second heating area is received while a first heating area among the plurality of heating areas is turned on, supply of a current to the first induction coil corresponding to the first heating area among the plurality of induction coils may be stopped during a threshold time. Detailed explanation in this regard will be made with reference to FIG. 2.

FIG. 2 illustrates a diagram illustrating an exterior of a cooking apparatus according to an embodiment of the disclosure.

Referring to FIG. 2, the cooking plate 110 provided on the cooking apparatus 100 may include a plurality of heating areas 110-1, 110-2, 110-3.

The plurality of heating areas 110-1, 110-2, 110-3 may have different shapes or sizes from one another. For example, the first heating area 110-1 and the second heating area 110-2 may be circular models, and the first heating area 110-1 may be provided on the upper side, and the second heating area 110-2 may be provided on the lower side. The third heating area 110-3 may be a rectangular model, and a magnetic field may be generated in all areas of the rectangular model. That is, all areas of the rectangular model may be heating areas.

Meanwhile, the cooking apparatus 100 according to an embodiment of the disclosure may include an input panel and a display corresponding to each of the plurality of heating areas 110-1, 110-2, 110-3.

Here, an input panel may receive a user instruction. For example, an input panel may have buttons that increase an output level (e.g., an output level up button) or decrease an output level (e.g., an output level down button). A display may display an output level of a heating area set according to a user instruction, state information of a heating area, an error code, etc.

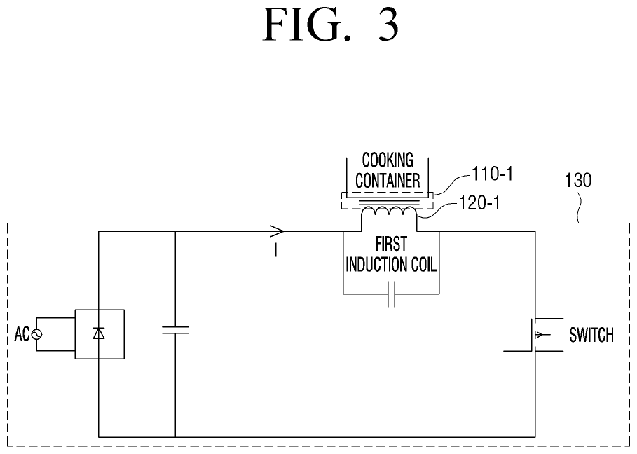

According to an embodiment of the disclosure, if a user instruction for turning on the first heating area 110-1 among the plurality of heating areas 110-1, 110-2, 110-3 is received, the processor 140 may control the driver 130 and supply a current to the first induction coil corresponding to the first heating area 110-1. Also, the processor 140 may control the strength of a current supplied to the first induction coil based on an output level corresponding to the user instruction. Detailed explanation in this regard will be made with reference to FIG. 3.

FIG. 3 illustrates a diagram for illustrating a driver and an induction coil according to an embodiment of the disclosure.

Referring to FIG. 3, the driver 130 according to an embodiment of the disclosure may be provided with power from an external power source, and supply currents to the induction coils 120 according to control by the processor 140. Also, the driver 130 according to an embodiment of the disclosure may include an electro magnetic interference (EMI) filter, a rectification circuit, and an inverter.

An EMI filter may block a high frequency noise included in alternating power provided from an external power source (ES) (e.g., a high frequency of alternating power), and make an alternating voltage and an alternating current of a predetermined frequency (e.g., 50 Hz or 60 Hz) pass through. An EMI filter 151 according to an embodiment of the disclosure may include an inductor L1 provided between input and output of the filter and a capacitor C1 provided between positive output and negative output of the filter. The inductor L1 may block passing of a high frequency noise, and the capacitor C1 may make a high frequency noise bypass to the external power source (ES).

By the EMI filter, alternating power wherein a high frequency noise has been blocked may be provided to a rectification circuit. A rectification circuit according to an embodiment of the disclosure may include bridge diodes. For example, a rectification circuit may include four diodes. The diodes may form diode pairs wherein diodes are serially connected in a pair of two, and the two diode pairs may be connected with each other in parallel. The bride diodes may convert an alternating voltage of which polarity changes according to time into a voltage having a specific amount of polarity, and convert an alternating current of which direction changes according to time into a current having a specific direction. That is, a rectification circuit may output an alternating voltage and an alternating current input from the EMI filter 151 as a serial voltage and a serial current.

An inverter circuit may include a switch that supplies or blocks currents to and from the induction coils 120 and a resonance circuit that generates resonance together with the induction coils 120.

Meanwhile, an inverter according to an embodiment of the disclosure may be implemented as a single-ended resonance type inverter which has a relatively simple circuit structure and has a low price compared to a half bridge type. A switch provided on a single-ended resonance type inverter may be turned on/turned off with 23 kHz (kilohertz) to 35 kHz.

According to an embodiment of the disclosure, the frequency of an alternating current supplied to the induction coils 120 may be determined according to the switching frequency of a switch provided on a single-ended resonance type inverter. Next, according to the frequency of an alternating current supplied to the induction coils 120, the strength of the magnetic field output by the induction coils 120 and the output power of the heating areas may change. As an example, if the switching frequency of the switch decreases, the strength of the magnetic field output by the induction coils 120 may increase, and the output power of the heating areas may increase.

The processor 140 may identify the strength of the magnetic field output by the induction coils 120 (or, the output power of the heating areas) from an output level according to a user instruction. As an example, the cooking apparatus 100 may further include a memory (not shown), and the memory may store a lookup table including information on an output level and the strength of the magnetic field (or, the output power of the heating areas) corresponding to the output level.

Also, the processor 140 may determine the output power of the heating areas from an output level according to a user instruction based on a lookup table. For example, the processor 140 may control the driver 130 such that the induction coils 120 output a magnetic field corresponding to power of 1200 W (watt) based on a user instruction of “level 6,” and control the driver 130 such that the induction coils 120 output a magnetic field corresponding to power of 1800 W (watt) based on a user instruction of “level 9.”

For example, if the processor 140 controls the driver 130 such that the switching frequency of the switch becomes 25 kHz, the driver 130 may supply an alternating current corresponding to the switching frequency 25 kHz to the first induction coil 120-1. Then, the first heating area 110-1 corresponding to the first induction coil 120-1 may output power of 1500 W according to the frequency of the supplied current, i.e., the strength of the current. As another example, if the processor 140 controls the driver 130 such that the switching frequency of the switch becomes 28 kHz, the driver 130 may supply an alternating current corresponding to the switching frequency 28 kHz to the first induction coil 120-1. Then, the first heating area 110-1 corresponding to the first induction coil 120-1 may output power of 1000 W according to the frequency of the supplied current, i.e., the strength of the current.

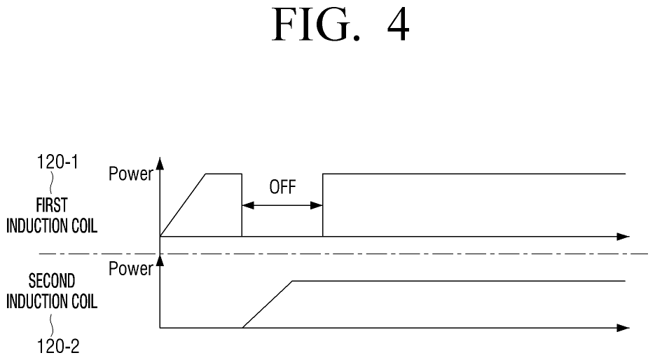

Meanwhile, if a user instruction for turning on the first heating area 110-1 is received, the processor 140 according to an embodiment of the disclosure may gradually increase the strength of a current supplied to the first induction coil 120-1 corresponding to the first heating area 110-1 among the plurality of induction coils. Detailed explanation in this regard will be made with reference to FIG. 4.

FIG. 4 illustrates a diagram for illustrating the strength of a current according to an embodiment of the disclosure.

Referring to FIG. 4, if a user instruction for turning on the first heating area 110-1 is received, the processor 140 may gradually decrease the frequency of a current supplied to the first induction coil 120-1 corresponding to the first heating area 110-1. For example, the processor 140 may gradually decrease the switching frequency of the switch provided on the driver 130 from 35 kHz to 23 kHz and thereby gradually increase the strength of a current supplied to the first induction coil 120-1. Meanwhile, for the convenience of explanation, explanation was made based on the assumption of a case wherein the variable switching frequencies of the switch are 23 kHz to 35 kHz. However, the disclosure is not limited thereto. The processor 140 may gradually decrease the switching frequency of the switch provided on the driver 130 from a high frequency to a low frequency within the range of variable frequencies. The cooking apparatus 100 according to an embodiment of the disclosure may supply currents to the induction coils 120 corresponding to a user instruction, or turn on the heating areas by a soft start method for maintaining the stability of the apparatus.

If the strength of the magnetic field output by the first induction coil 120-1 corresponds to an output level set according to a user instruction, the processor 140 according to an embodiment of the disclosure may maintain the strength of a current supplied to the first induction coil 120-1.

If a user instruction for turning on the second heating area 110-2 is received while the first heating area 110-1 among the plurality of heating areas 110-1, 110-2, 110-3 is turned on, the processor 140 according to an embodiment of the disclosure may stop supply of a current to the first induction coil 120-1 corresponding to the first heating area 110-1 among the plurality of induction coils 120 during a threshold time.

The processor 140 may gradually increase the strength of a current supplied to the second induction coil 120-2 corresponding to the second heating area 110-2 based on a user instruction for turning on the second heating area 110-2. That is, the processor 140 may gradually decrease the frequency of a current supplied to the second induction coil 120-2. For changing the frequency of a current supplied to the second induction coil 120-2, the switching frequency of the switch provided on the driver 130 may gradually decrease from 35kHz to 23kHz. In this case, a magnetic field interference noise may be output as much as the difference between frequencies of currents supplied to each of the first induction coil 120-1 and the second induction coil 120-2. For example, if the difference between the frequency of a current supplied to the first induction coil 120-1 and the frequency of a current supplied to the second induction coil 120-2 is included in approximately 2 kHz to 18 kHz, the cooking apparatus 100 may output a noise within a range of audible frequencies that humans can recognize.

Such a noise may give an unpleasant feeling to a user who uses the cooking apparatus 100, and accordingly, if a user instruction for supplying a current to the second induction coil 120-2 is received while a current is being supplied to the first induction coil 120-1, the processor 140 may stop supply of a current to the first induction coil 120-1 during a threshold time. Then, the processor 140 may supply a current having strength corresponding to an output level according to the user instruction to the second induction coil 120-2 within the threshold time.

Referring to FIG. 4, the processor 140 may stop supply of a current to the first induction coil 120-1 during a threshold time, for example, 6sec, and start supply of a current to the second induction coil 120-2. Then, the processor 140 may gradually increase the strength of the current supplied to the second induction coil 120-2, and if the strength of the current supplied to the second induction coil 120-2 (or, the strength of the magnetic field output by the second induction coil 120-2) corresponds to an output level set according to the user instruction, the processor 140 may maintain the strength of the current supplied to the second induction coil 120-2. Here, the threshold time may be time that is required for the strength of the current supplied to the second induction coil 120-2 corresponding to the second heating area 110-2 to be identical to the strength of the current corresponding to the user instruction.

Then, the processor 140 may resume supply of a current to the first induction coil 120-1 that was stopped.

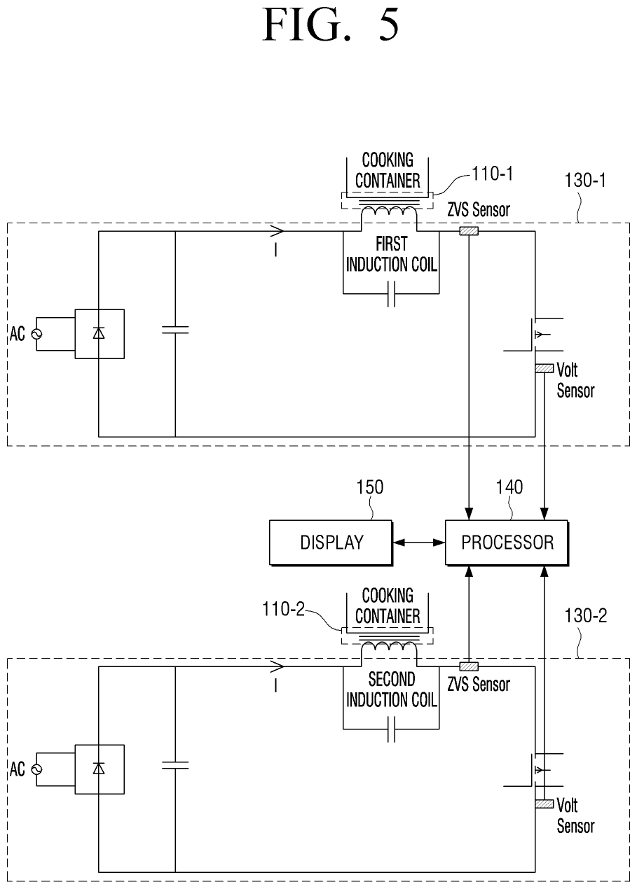

While both of the first heating area 110-1 and the second heating area 110-2 are turned on, the processor 140 according to an embodiment of the disclosure may control the driver 130 to adjust the strength of at least one of the first current or the second current such that the difference between the strength of the first current supplied to the first induction coil 120-1 and the strength of the second current supplied to the second induction coil 120-2 corresponding to the second heating area 110-2 belongs to a threshold range. Detailed explanation in this regard will be made with reference to FIG. 5.

FIG. 5 illustrates a diagram of an exemplary detailed configuration of a driver according to an embodiment of the disclosure.

The cooking apparatus 100 according to an embodiment of the disclosure may include a first driver 130-1 supplying a current to the first induction coil 120-1 and a second driver 130-2 supplying a current to the second induction coil 120-2. Each of the first and second drivers 130-1, 130-2 may include a switch for controlling the frequency of a current supplied to the induction coils 120.

As the variable switching frequencies of the switch provided on the driver 130 according to an embodiment of the disclosure are approximately 23 kHz (kilohertz) to 35 kHz, the strength of the magnetic field output by the induction coils 120, i.e., the output power output by the heating areas corresponding to the induction coils 120 may be limited to approximately 1000 W to 2200 W.

According to an embodiment of the disclosure, the cooking apparatus 100 including a single-ended resonance type inverter may include a separate switch and control turning-on/turning-off of the induction coils or the heating areas themselves.

If the output power corresponding to an output level according to a user instruction is smaller than 1000 W, the processor 140 may control the separate switch and thereby control whether to turn on/turn off the induction coils 120 themselves or to output power of the heating areas. For example, a case wherein an output level according to a user instruction is ‘level 3,’ and output power corresponding to ‘level 3’ is approximately 600 W may be assumed.

As the variable output powers of the heating areas are 1000 W to 2200 W, the processor 140 may control whether to output the power of the heating areas by a specific cycle such that the average output power of the heating areas during a predetermined time becomes 600 W. For example, the processor 140 may turn on/turn off the induction coils 120 or the heating areas themselves by a cycle of 0.1 sec such that the average output power of the heating areas during one minute becomes 600 W.

The memory provided in the cooking apparatus 100 according to an embodiment of the disclosure may store a lookup table including information on an output level, the strength of the magnetic field (or, the output power of the heating areas) corresponding to an output level, and the average output power according to the turning-on/turning-off cycle of the heating areas. The lookup table may be in a form as the Table 1 below.

| | Output Level of the First Heating Area | | | | | | | | | | |
|---|---|---|---|---|---|---|---|---|---|---|---|
| | Off | 1 | 2 | 3 | 4 | 5 | 6 | 7 | 8 | 9 | P |
| Output | Off | 5/5 | | | | | 6/5 | 7/7 | 8/7 | 9/7 | 9/7 |
| Level | 1 | | | | | | | | | | |
| of the | 2 | | | | | | | | | | |
| Second | 3 | | | | | | | | | | |
| Heating | 4 | | | | | | | | | | |
| Area | 5 | | | | | | | | | | |
| | 6 | 5/6 | | | | | 6/6 | | | | |
| | 7 | 7/7 | | | | | | 7/7 | 8/7 | 9/7 | N/A |
| | 8 | 7/8 | | | | | | 7/8 | 8/8 | 8/9 | N/A |
| | 9 | 7/9 | | | | | | 7/9 | 8/9 | 9/9 | N/A |
| | P | 7/9 | | | | | | N/A | N/A | N/A | N/A |

Here, the value of each cell may be (the output power of the first heating area)/(the output power of the second heating area).

Referring to the Table 1, if the output level of the first heating area 110-1 according to a user instruction is smaller than or equal to 5, the processor 140 may control the strength of the magnetic field of the first induction coil 120-1 corresponding to the first heating area 110-1 such that the output power of the first heating area 110-1 becomes 5. As an example, if the output level of the first heating area 110-1 according to a user instruction is 3, the processor 140 may control the driver 130 such that the frequency of a current supplied to the first induction coil 120-1 corresponds to output power 5, and turn on/turn off the first induction coil 120-1 itself by a specific cycle based on the lookup table such that the average output power of the first heating area 110-1 corresponds to ‘output level 3.’

Meanwhile, in case the plurality of induction coils 120-1, 120-2, 120-3 are driven simultaneously, the processor 140 may control the frequencies of currents and the supply time of currents such that the difference among the frequencies of currents supplied to each of the plurality of induction coils 120-1, 120-2, 120-3 does not belong to the range of audible frequencies.

The driver 130 according to an embodiment of the disclosure may respectively include a switch controlling the supply time of a current supplied to the induction coil 120 and a switch for controlling the frequency of a current supplied to the induction coil 120. For example, a first driver 130-1 providing a first current to the first induction coil 120-1 may include a first switch for controlling the supply time of the first current and a second switch for controlling the frequency of the first current. Also, the first driver 130-1 supplying a second current to the second induction coil 120-2 may include a third switch for controlling the supply time of the second current and a fourth switch for controlling the frequency of the second current.

As an example, a case wherein the frequency of the first current supplied to the first induction coil 120-1 corresponds to the output level 5, and the frequency of the second current supplied to the second induction coil 120-2 corresponds to the output level 9 may be assumed. In this case, the difference between the frequency of the first current supplied to the first induction coil 120-1 and the frequency of the second current supplied to the second induction coil 120-2 may be included within 2 kHz to 18 kHz. As the difference between the frequencies belongs to the range of audible frequencies of humans, there is a problem that a noise that may give an unpleasant feeling to the user of the cooking apparatus 100 occurs.

The processor 140 according to an embodiment of the disclosure may adjust at least one frequency between the frequency (or, the strength) of the first current supplied to the first induction coil 120-1 or the frequency of the second current supplied to the second induction coil 120-2, such that the difference between the frequency of the first current and the frequency of the second current does not belong to the range of audible frequencies (e.g., 2 kHz to 18 kHz).

For example, if the frequency of the first current supplied to the first induction coil 120-1 corresponds to the output level 5, and the frequency of the second current supplied to the second induction coil 120-2 corresponds to the output level 9, the processor 140 may control the switching frequency of the second switch included in the first driver 130-1 and thereby adjust the frequency of the first current supplied to the first induction coil 120-1 to correspond to the output level 7, and maintain the frequency of the second current supplied to the second induction coil 120-2.

Then, if the strength of at least one of the first current or the second current is adjusted, the processor 140 may adjust the time that the current of which strength has been adjusted is supplied based on the adjusted strength of the current. According to an embodiment of the disclosure, if the first current is adjusted, the processor 140 may control the switching frequency of the first switch included in the first driver 130 and thereby control the supply time of the first current. For example, the processor 140 may turn on/turn off the first heating area itself by a specific cycle such that the average output power of the first heating area 120-1 corresponding to the first induction coil 120-1 becomes 1000 W which corresponds to ‘the output level 5.’

Here, turning-off of a heating area itself may mean stopping supply of a current to the induction coil 120 corresponding to the heating area, and stopping driving of the driver 130 corresponding to the heating area.

If a user instruction is received, the processor 140 according to another embodiment of the disclosure may identify a heating area corresponding to the user instruction among the plurality of heating areas 110-1, 110-2, 110-3. Then, the processor 140 may identify an output level corresponding to the user instruction. If another heating area adjacent to the heating area corresponding to the user instruction is in a turned-on state, the processor 140 may compare the identified output level and the output level of the another heating area. Then, based on the comparison result, if the difference between the identified output level and the output level of the another area exceeds two levels, the processor 140 may control the strength of the magnetic field output by the induction coil 120 to adjust the output level of any one of the heating area corresponding to the user instruction or the another heating area.

For example, if a user instruction is received, the processor 140 may identify the first heating area 110-1 corresponding to the user instruction among the plurality of heating areas 110-1, 110-2, 110-3. Then, if the second heating area 110-2 adjacent to the first heating area 110-1 among the plurality of heating areas 110-1, 110-2, 110-3 is in a turned-on state, the processor 140 may identify the output level of the second heating area 110-2.

Then, the processor 140 may compare the output level of the first heating area 110-1 according to the user instruction and the identified output level of the second heating area 110-2.

If the difference between the output level of the first heating area 110-1 and the identified output level of the second heating area 110-2 exceeds two levels based on the comparison result, the processor 140 according to an embodiment of the disclosure may adjust at least one of the output level of the first heating area 110-1 or the output level of the second heating area 110-2. As an example, the processor 140 may identify a heating area corresponding to the smaller output level between the first or the second heating areas 110-1, 110-2, and increase the output level of the identified heating area.

For example, if the output level of the first heating area 110-1 is 9, and the output level of the second heating area 110-2 is 5, the processor 140 may adjust the output level of the second heating area 110-2 between the output level of the first heating area 110-1 or the output level of the second heating area 110-2 from 5 to 7. Then, the processor 140 may control whether to output the power of the second heating area 110-2. For example, the processor 140 may control the supply time of a current to the second induction coil 120-2 corresponding to the second heating area 110-2.

As another example, the processor 140 may adjust the output level of the second heating area 110-2 between the output level of the first heating area 110-1 or the output level of the second heating area 110-2 from 5 to 8 or 9. If the output level of the second heating area 110-2 has been adjusted from 5 to 8, the processor 140 may adjust the time that a current is supplied to the second induction coil 120-2 such that the average output power of the second heating area 110-2 is identical to the output power before the adjustment (for example, output power corresponding to the output level 5). That is, if the first heating area 110-1 and the second heating area 110-2 are simultaneously in a turned-on state, the processor 140 may adjust at least one of the output level of the first heating area 110-1 or the output level of the second heating area 110-2 such that the difference between the output level of the first heating area 110-1 and the output level of the second heating area 110-2 becomes within two levels.

The processor 140 according to an embodiment of the disclosure may increase the strength of at least one of the first current supplied to the first induction coil 120-1 or the second current supplied to the second induction coil 120-2, and generate a pulse width modulation (PWM) signal for adjusting the time that the current of which strength has been increased is supplied based on the increased strength of the current, and provide the signal to the driver 130.

For example, the processor 140 may increase the first current supplied to the first induction coil 120-1 such that the difference between the strength of the magnetic field output by the first induction coil 120-1 and the strength of the magnetic field output by the second induction coil 120-2 belongs to a threshold range.

Then, the processor 140 may shorten the supply time of the current such that the average output power of the first heating area 110-1 corresponding to the first induction coil 120-1 becomes identical to the output power of the first heating area 110-1 before the strength of the current has been adjusted. Further, the processor 140 may provide a pulse width modulation (PWM) signal turning on/turning off the driving of the first driver 130-1 supplying a current to the first induction coil 120-1 based on the increased strength of the current to the first switch.

Here, the frequency of the PWM signal may mean the switching frequency controlling turning-on/turning-off of the first switch.

Meanwhile, the processor 140 according to an embodiment of the disclosure may measure the peak point of a resonance voltage, and if the resonance voltage of the peak point is the threshold voltage (e.g., 1,200V), the processor 140 may control the driver 130 such that the strength of the magnetic field of the induction coil is maintained.

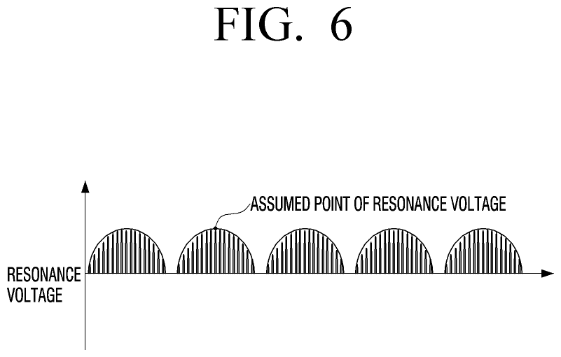

Detailed explanation in this regard will be made with reference to FIG. 6.

FIG. 6 illustrates an exemplary diagram of a resonance voltage according to an embodiment of the disclosure.

In the single-ended inverter provided on the driver 130 according to an embodiment of the disclosure, a high resonance voltage may be generated by voltage resonance. When a switch is turned on, current energy flowing in the induction coil 120 is accumulated as voltage energy of the resonance capacitor when the switch is turned off, and there is a risk that a high voltage stress may be applied to the switch. Accordingly, a switch according to an embodiment of the disclosure may be implemented as an insulated gate bipolar transistor (IGBT) having a high breakdown voltage of 1,200V or more.

The cooking apparatus according to an embodiment of the disclosure may include a voltage detection sensor (e.g., a volt sensor) sensing the voltages of both ends of the switch. The processor 140 may identify the strength of the magnetic field of the induction coil 120 and the output power of the heating area based on a sensing value of the voltage detection sensor. Then, if the sensing value exceeds a threshold value, the processor 140 may control the driver 130 such that the current output power is maintained even if the output power of the heating area does not correspond to the output level according to a user instruction.

The processor 140 may sense an output signal of the induction coil or the strength of the magnetic field output by the induction coil by a time interval determined based on the frequency (e.g., the driving frequency) of a current supplied from the driver 130 to the induction coil 120. For example, the processor 140 may control the voltage detection sensor to detect the voltages of both ends of the switch at an interval of a specific cycle based on the frequency of the current. As an example, the peak point of a resonance voltage is generally generated on the half (T/2) point of the cycle. Thus, the processor 140 may not control the voltage detection sensor to detect the voltages applied to both ends of the switch across all cycles, but control the voltage detection sensor to detect voltages applied to both ends of the switch on the half point of the cycle expected to be the peak point.

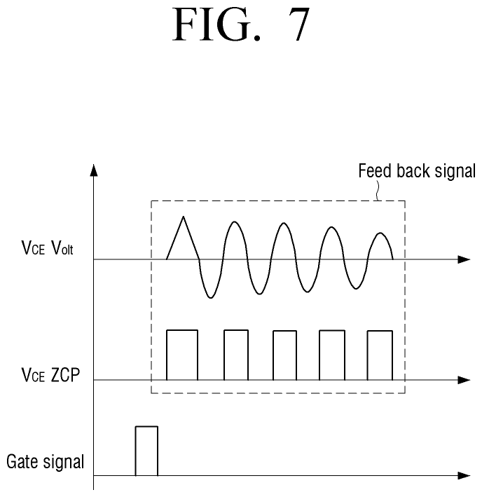

FIG. 7 illustrates a diagram for illustrating a feedback signal according to an embodiment of the disclosure.

The processor 140 according to an embodiment of the disclosure may transmit a PWM signal for controlling the operation of the driver 130 or whether to supply a current to the first induction coil 120-1 to the driver 130, and then, if a feedback signal corresponding to the PWM signal is not received from the driver 130, the processor 140 may stop supply of a current to the first induction coil 120-1 by controlling the first switch provided on the driver 130.

The cooking apparatus 100 according to an embodiment of the disclosure may include a current sensor for measuring a current output from the inverter provided on the driver 130. If a feedback signal is not received from the driver 130 or a current value is not sensed from the current sensor even though the processor 140 operated the driver 130 and transmitted a PWM signal for supplying a current to the first induction coil 120-1 to the driver 130, the processor 140 may stop supply of a current to the first induction coil 120-1. For example, a phenomenon that a feedback signal is not detected means that breakdown of the cooking apparatus 100 occurred or there is a risk that breakdown may occur, and thus the processor 140 may stop the operation of the driver 130 or stop the output of a magnetic field by the induction coil 120.

If a feedback signal is not received from the driver 130 after the processor 140 according to an embodiment of the disclosure transmitted a PWM signal to the driver 130, the processor 140 may control the display 150 to display an error code.

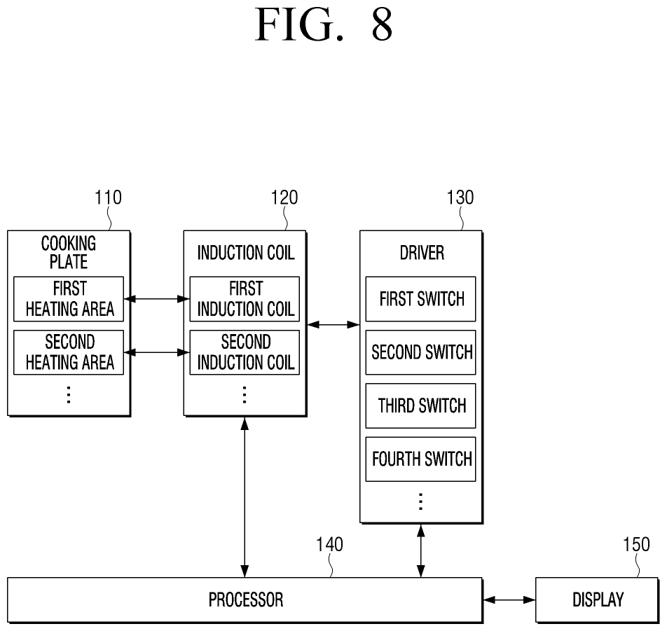

FIG. 8 illustrates a block diagram illustrating a detailed configuration of a cooking apparatus according to an embodiment of the disclosure.

Referring to FIG. 8, the cooking apparatus 100 may include a cooking plate 110, a plurality of induction coils 120, a driver 130, a processor 140, and a display 150. Meanwhile, operations and components overlapping with those explained above will be omitted.

The cooking plate 110 may include first to nth heating areas 110-1, . . . 110-n. Each of the plurality of induction coils 120 may correspond to the heating areas.

The driver 130 may be provided to correspond to each of the plurality of induction coils 120. As an example, the first driver 130-1 may supply a current to the first induction coil 120-1, and the second driver 130-2 may supply a current to the second induction coil 120-2. Here, the first driver 130-1 may include a first switch for controlling the time that a current is supplied to the first induction coil 120-1 and a second switch for controlling the strength of the current supplied to the first induction 120-1. The second driver 130-2 may include a third switch for controlling the time that a current is supplied to the second induction coil 120-2 and a fourth switch for controlling the strength of the current supplied to the second induction coil 120-2.

The display 150 may be implemented as various display technologies such as a Liquid Crystal Display (LCD), Organic Light-Emitting Diodes (OLED), Active-Matrix Organic Light-Emitting Diodes (AM-OLED), Liquid Crystal on Silicon (LcoS), Digital Light Processing (DLP), or a Seven-segment display, etc.

Meanwhile, the cooking apparatus 100 according to an embodiment of the disclosure may include a container detection sensor (not shown).

The container detection sensor may detect a cooking container placed on the cooking plate 110 and transmit the detection result to the processor 140.

Also, the container detection sensor may identify the induction coils 120 overlapped with the cooking container. For example, the processor 140 may measure the sizes of currents flowing in the induction coils, and compare the measured sizes of the currents and the size of the reference current and thereby identify the induction coils 120 overlapped with the cooking container.

As the area or the number of the induction coils 120 overlapped with the cooking container increases, the resistance value of the resistor increases; and accordingly, as the size of the cooking container increases at the same output power, the strength of the current decreases (or, the frequency of the current increases).

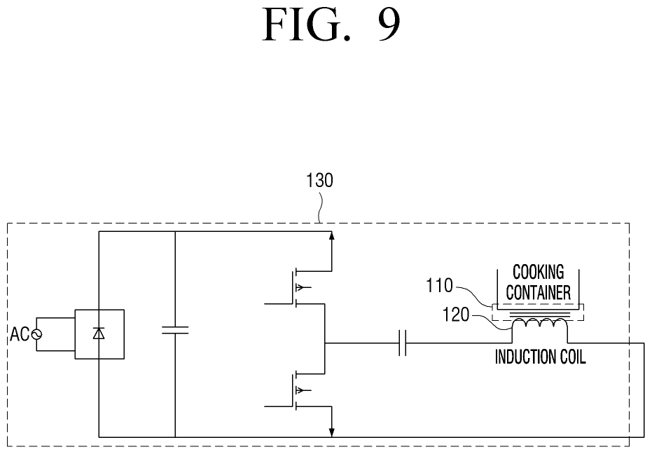

FIG. 9 illustrates a diagram for illustrating a driver according to another embodiment of the disclosure.

The driver 130 according to another embodiment of the disclosure may include a plurality of switches. As an example, the inverter provided on the driver 130 may be implemented by a half bridge method.

The first switch and the second switch provided on the driver 130 may be turned on or turned off according to control by the processor 140. Also, according to turning-on/turning-off of the first switch and the second switch, a current may flow through the first switch and the second switch to the induction coil 120, or from the induction coil 120 through the first switch and the second switch.

For example, if the first switch is closed (turned on) and the second switch is opened (turned off), a current may flow through the first switch to the induction coil 120. Also, if the first switch is opened (turned off), and the second switch is closed (turned on), a current may flow from the induction coil 120 through the second switch. As the first switch and the second switch are turned on/turned off at a high speed of 20 kHz to 70 kHz, the first switch and the second switch may be implemented as a bipolar junction transistor (BJT) having a fast response speed, a metal-oxide-semiconductor field effect transistor (MOSFET), an insulated gate bipolar transistor (IGBT), a thyristor, etc.

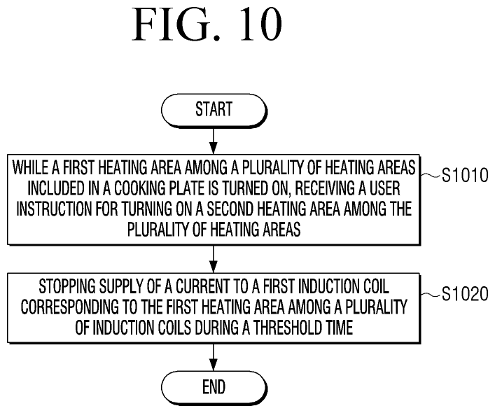

FIG. 10 illustrates a flow chart for illustrating a driving method of a cooking apparatus according to an embodiment of the disclosure.

In a driving method of a cooking apparatus according to an embodiment of the disclosure, first, while a first heating area among a plurality of heating areas included in the cooking plate is turned on, a user instruction for turning on a second heating area among the plurality of heating areas is received at operation S1010.

Then, supply of a current to a first induction coil corresponding to the first heating area among a plurality of induction coils is stopped during a threshold time at operation S1020.

The driving method according to an embodiment of the disclosure may include the step of, while both of the first heating area and the second heating area are turned on, controlling the driver to adjust the strength of at least one of a first current or a second current such that the difference between the strength of the first current supplied to the first induction coil and the strength of the second current supplied to the second induction coil corresponding to the second heating area belongs to a threshold range.

Here, the step of controlling the driver may include the step of, based on the strength of at least one of the first current or the second current being adjusted, adjusting the time that the current of which strength has been adjusted is supplied based on the adjusted strength of the current.

Also, the step of controlling the driver may include the steps of increasing the strength of at least one of the first current or the second current, generating a pulse width modulation (PWM) signal for adjusting the time that the current of which strength has been increased is supplied based on the increased strength of the current, and providing the signal to the driver.

In addition, the step of controlling the driver may include the step of adjusting the time that the current of which strength has been adjusted is supplied such that the average output power of the heating area corresponding to the induction coil to which the current of which strength has been adjusted is supplied is identical to the output power before the adjustment.

Here, the driver may include a first switch controlling supply of a current to the first induction coil, a second switch controlling the frequency of the current supplied to the first induction coil, a third switch controlling supply of a current to the second induction coil, and a fourth switch controlling the frequency of the current supplied to the second induction coil.

Also, the step of controlling the driver according to an embodiment of the disclosure may include the steps of controlling the supply time of the first current by controlling the switching frequency of the first switch, controlling the supply time of the second current by controlling the switching frequency of the third switch, controlling the strength of the first current by controlling the switching frequency of the second switch, and controlling the strength of the second current by controlling the switching frequency of the fourth switch.

Meanwhile, the driving method according to an embodiment of the disclosure may include the steps of transmitting a pulse width modulation (PWM) signal for controlling supply of a current to the first induction coil to the driver, and based on a feedback signal corresponding to the PWM signal not being received from the driver, controlling the first switch and stopping supply of a current to the first induction coil.

Also, the driving method according to an embodiment of the disclosure may include the step of, based on a user instruction for turning on the second heating area being received, gradually increasing the strength of a current supplied to the second induction coil corresponding to the second heating area among the plurality of induction coils.

Meanwhile, the threshold time may be time required for the strength of the current supplied to the second induction coil corresponding to the second heating area to be identical to the strength of the current corresponding to the user instruction.

In addition, the driving method according to an embodiment of the disclosure may include the steps of sensing an output signal of the first induction coil by a time interval determined based on a driving frequency of the first induction coil, and based on the size of the output signal being greater than or equal to a threshold size based on the maximum size among the sensed sizes of the output signal, controlling the driver such that the size of the output signal of the first induction coil maintains the threshold size.

Meanwhile, the various embodiments described above may be implemented in a recording medium that can be read by a computer or an apparatus similar to a computer, by using software, hardware, or a combination thereof. In some cases, the embodiments described in this specification may be implemented as a processor itself. According to implementation by software, the embodiments such as processes and functions described in this specification may be implemented by separate software modules. Each of the software modules can perform one or more functions and operations described in this specification.

Meanwhile, computer instructions for performing processing operations of the electronic apparatus 100 according to the aforementioned various embodiments of the disclosure may be stored in a non-transitory computer-readable medium. Computer instructions stored in such a non-transitory computer-readable medium make the processing operations at the electronic apparatus 100 according to the aforementioned various embodiments performed by a specific machine, when the instructions are executed by the processor of the specific machine.

A non-transitory computer-readable medium refers to a medium that stores data semi-permanently, and is readable by machines, but not a medium that stores data for a short moment such as a register, a cache, and a memory. As specific examples of a non-transitory computer-readable medium, there may be a CD, a DVD, a hard disc, a blue-ray disc, a USB, a memory card, a ROM and the like.

Although the present disclosure has been described with various embodiments, various changes and modifications may be suggested to one skilled in the art. It is intended that the present disclosure encompass such changes and modifications as fall within the scope of the appended claims.

What is claimed is:

1. A cooking apparatus comprising:
a cooking plate including a plurality of heating areas;
a plurality of induction coils that are included in locations corresponding to each of the plurality of heating areas in the lower part of the cooking plate;
a driver supplying currents to each of the plurality of induction coils; and
a processor configured to:
based on receiving a user instruction for turning on a second heating area among the plurality of heating areas being received while a first heating area among the plurality of heating areas is turned on, stop the supply of a current to a first induction coil corresponding to the first heating area among the plurality of induction coils during a threshold time.

2. The cooking apparatus of claim 1, wherein the processor is further configured to:
while both of the first heating area and the second heating area are turned on, control the driver to adjust a strength of at least one of a first current or a second current such that a difference between the strength of the first current supplied to the first induction coil and the strength of the second current supplied to a second induction coil corresponding to the second heating area is within a threshold range.

3. The cooking apparatus of claim 2, wherein the processor is configured to:
based on the strength of at least one of the first current or the second current being adjusted, adjust the time that the current of the strength that has been adjusted is supplied based on the adjusted strength of the current.

4. The cooking apparatus of claim 3, wherein the processor is further configured to:
increase the strength of at least one of the first current or the second current, generate a pulse width modulation (PWM) signal for adjusting the time that the current of the strength that has been increased is supplied based on the increased strength of the current; and transmit the signal to the driver.

5. The cooking apparatus of claim 3, wherein the processor is further configured to:
adjust the time that the current of the strength that has been adjusted is supplied such that an average output power of a heating area corresponding to an induction coil to which the current of the strength that has been adjusted is supplied is identical to an output power before the adjustment.

6. The cooking apparatus of claim 3, wherein the driver further comprises:
a first switch controlling supply of a current to the first induction coil;
a second switch controlling a frequency of the current supplied to the first induction coil;
a third switch controlling supply of a current to the second induction coil; and
a fourth switch controlling the frequency of the current supplied to the second induction coil;
and the processor is further configured to:
control a supply time of the first current by controlling the switching frequency of the first switch,
control the supply time of the second current by controlling the switching frequency of the third switch,
control the strength of the first current by controlling the switching frequency of the second switch, and
control the strength of the second current by controlling the switching frequency of the fourth switch.

7. The cooking apparatus of claim 6, wherein the processor is further configured to:
after transmitting a pulse width modulation (PWM) signal for controlling supply of a current to the first induction coil to the driver, based on a feedback signal corresponding to the PWM signal not being received from the driver, control the first switch and stop supply of a current to the first induction coil.

8. The cooking apparatus of claim 1, wherein the processor is further configured to:
based on a user instruction for turning on the second heating area being received, gradually increase a strength of a current supplied to a second induction coil corresponding to the second heating area among the plurality of induction coils.

9. The cooking apparatus of claim 1, wherein the threshold time is time required for a strength of the current supplied to a second induction coil corresponding to the second heating area to be identical to the strength of the current corresponding to the user instruction.

10. The cooking apparatus of claim 1, wherein the processor is further configured to:
sense an output signal of the first induction coil by a time interval determined based on a driving frequency of the first induction coil, and
based on the size of the output signal being greater than or equal to a threshold size based on the maximum size among the sensed sizes of the output signal, control the driver such that the size of the output signal of the first induction coil maintains the threshold size.

11. A driving method of a cooking apparatus comprising a cooking plate, a plurality of induction coils that are included in the lower part of the cooking plate, and a driver supplying currents to each of the plurality of induction coils, the method comprising:
receiving a user instruction for turning on a second heating area among a plurality of heating areas while a first heating area among the plurality of heating areas included in the cooking plate is turned on; and
stopping the supply of a current to a first induction coil corresponding to the first heating area among the plurality of induction coils during a threshold time.

12. The driving method of claim 11, further comprising:
while both of the first heating area and the second heating area are turned on, controlling the driver to adjust a strength of at least one of a first current or a second current such that a difference between the strength of the first current supplied to the first induction coil and the strength of the second current supplied to a second induction coil corresponding to the second heating area are within a threshold range.

13. The driving method of claim 12, wherein the controlling the driver comprises:
based on the strength of at least one of the first current or the second current being adjusted, adjusting the time that the current of the strength that has been adjusted is supplied based on the adjusted strength of the current.

14. The driving method of claim 13, wherein the controlling the driver further comprises:
increasing the strength of at least one of the first current or the second current, generating a pulse width modulation (PWM) signal for adjusting the time that the current of the strength that has been increased is supplied based on the increased strength of the current; and transmitting the signal to the driver.

15. The driving method of claim 13, wherein the controlling the driver further comprises:
adjusting the time that the current of the strength that has been adjusted is supplied such that an average output power of a heating area corresponding to an induction coil to which the current of the strength that has been adjusted is supplied is identical to an output power before the adjustment.

16. The driving method of claim 13, wherein the driver further comprises:
a first switch controlling supply of a current to the first induction coil;
a second switch controlling a frequency of the current supplied to the first induction coil;
a third switch controlling supply of a current to the second induction coil; and
a fourth switch controlling the frequency of the current supplied to the second induction coil;
and the controlling the driver further comprises:
controlling a supply time of the first current by controlling the switching frequency of the first switch;
controlling the supply time of the second current by controlling the switching frequency of the third switch;
controlling the strength of the first current by controlling the switching frequency of the second switch; and
controlling the strength of the second current by controlling the switching frequency of the fourth switch.

17. The driving method of claim 16, further comprising:
transmitting a pulse width modulation (PWM) signal for controlling supply of a current to the first induction coil to the driver; and
based on a feedback signal corresponding to the PWM signal not being received from the driver, controlling the first switch and stopping supply of a current to the first induction coil.

18. The driving method of claim 11, further comprising:
based on a user instruction for turning on the second heating area being received, gradually increasing a strength of a current supplied to a second induction coil corresponding to the second heating area among the plurality of induction coils.

19. The driving method of claim 11, wherein the threshold time is time required for a strength of the current supplied to a second induction coil corresponding to the second heating area to be identical to the strength of the current corresponding to the user instruction.

20. The driving method of claim 11, further comprising:
sensing an output signal of the first induction coil by a time interval determined based on a driving frequency of the first induction coil; and
based on the size of the output signal being greater than or equal to a threshold size based on the maximum size among the sensed sizes of the output signal, controlling the driver such that the size of the output signal of the first induction coil maintains the threshold size.
